(19) United States
(12) Patent Application Publication
(10) Pub. No.: US 2015/0379936 A1
(43) Pub. Date: Dec. 31, 2015

(54) ORGANIC LIGHT EMITTING DISPLAY PANEL AND METHOD OF OPERATING THE SAME

(71) Applicant: SAMSUNG DISPLAY CO., LTD., Yongin-City (KR)

(72) Inventor: Hyun-Ho LIM, Jecheon-si (KR)

(21) Appl. No.: 14/618,169

(22) Filed: Feb. 10, 2015

(30) Foreign Application Priority Data
Jun. 26, 2014 (KR) 10-2014-0078797

(51) Int. Cl. G09G 3/32

(52) U.S. Cl. CPC G09G 3/3266; G09G 3/3275; G09G 2310/0278

(57) ABSTRACT

An organic light emitting display device includes a display panel, a data driver, a scan driver, a switch controller, and a timing controller. The display panel includes a plurality of data lines, a plurality of scan lines, a first switch control line, and a plurality of pixels. The data lines include first switches connected to the first switch control line. The data driver outputs a data signal to the data lines. The scan driver outputs a scan signal to the scan lines. The switch controller outputs a first switch control signal to the first switch control line based on a location of a selected scan line to which the scan signal is applied. The timing controller controls the data driver, the scan driver, and the switch controller.

### CROSS REFERENCE TO RELATED APPLICATION

Korean Patent Applications No. 10-2014-0078797, filed on Jun. 26, 2014, and entitled, “Organic Light Emitting Display Panel and Method of Operating the Same,” is incorporated by reference herein in its entirety.

### BACKGROUND

1. Field

One or more embodiments described herein relate to an organic light emitting display device and a method of operating an organic light emitting display device.

2. Description of the Related Art

An organic light emitting display generates images using pixels having organic light emitting diodes. Each diode generates light based on a recombination of electrons and holes in an active layer. Displays of this type offer numerous advantages including fast response speed and low power consumption.

As the size and resolution of an organic light emitting display increases, the number of pixels and display panel load increase. (The display panel load may be based, for example, on increasing resistance (or impedance) of panel lines and parasitic capacitance). Consequently, the pixel driving voltage and current supplied from a data driver to the panel may be increased in an attempt to maintain display quality. However, an increase in drive current causes a commensurate increase in power consumption. Also, the display panel and driver integrated circuits experience heating problems.

### SUMMARY

In accordance with one embodiment, an organic light emitting display device which includes a display panel including a plurality of data lines, a plurality of scan lines, a first switch control line, and a plurality of pixels, the data lines including first switches connected to the first switch control line, a data driver to output a data signal to the data lines; a scan driver to output a scan signal to the scan lines; a switch controller to output a first switch control signal to the first switch control line based on a location of a selected scan line to which the scan signal is applied; and a timing controller to control the data driver, the scan driver, and the switch controller.

The first switch may be turned on when a turn-on voltage of the first switch control signal is applied from the first switch control line to the first switch, and may be turned off when a turn-off voltage of the first switch control signal is applied from the first switch control line to the first switch. The first switch control line may be connected to a gate electrode of the first switch. The first switch may be turned off when the selected scan line is in a first scan region of the display panel.

The first scan region may be closer to the data driver than the first switch control line. The first switch may be turned on when the selected scan line is located in a second scan region of the display panel. The second scan region may be farther from the data driver than the first switch control line. The number of the scan lines in the first scan region may be equal to a number of the scan lines in the second scan region. The number of the scan lines in the first scan region may be different from a number of the scan lines in the second scan region.

Each of the data lines may include a second switch located farther from the data driver than the first switch. The display panel may include a second switch control line farther from the data driver than the first switch control line, the second switch control line connected to a gate electrode of the second switch.

The switch controller may output a second switch control signal to the second switch control line based on the location of the selected scan line, and the second switch may be turned on when a turn-on voltage of the second switch control signal is applied from the second switch control line to the second switch, and may be turned off when a turn-off voltage of the second switch control signal is applied from the second switch control line to the second switch.

The first switch and the second switch may be turned off when the selected scan line is in a first scan region of the display panel. The first switch may be turned on and the second switch is turned off when the selected scan line is in a second scan region of the display panel. The first switch and the second switch may be turned on when the selected scan line is in a third scan region of the display panel.

The first scan region may be closer to the data driver than the first switch control line, the second scan region may be between the first switch control line and the second switch control line, and the third scan region may be farther from the data driver than the second switch control line.

In accordance with another embodiment, a method of driving an organic light emitting display device performing a digital driving technique includes outputting a scan signal and a data signal; detecting a location of a selected scan line to which the scan signal is applied; outputting a turn-off voltage of a switch control signal to a switch control line when the location of the selected scan line is in a first scan region closer to a data driver than the switch control line; turning off a switch connected with the switch control line by the turn-off voltage of the switch control signal to apply the data signal to a pixel in the first scan region, the switch included in the data line; outputting a turn-on voltage of the switch control signal to the switch control line when the location of the selected scan line is in a second scan region farther from the data driver than the switch control line; and turning on the switch by the turn-on voltage of the switch control signal to apply the data signal to a pixel in a second scan region.

The number of the scan lines in the first scan region may be equal to a number of the scan lines in the second scan region. The number of the scan lines in the first scan region may be different from a number of the scan lines in the second scan region.

In accordance with another embodiment, an apparatus includes an interface and a controller to output a first switch control signal to a first switch control line through the interface, wherein the first control line is connected to first switches in a respective number of data lines in a display panel, and wherein the controller is to output the first switch control signal based on a location of a selected scan line to which a scan signal is applied in the display panel.

### BRIEF DESCRIPTION OF THE DRAWINGS

Features will become apparent to those of skill in the art by describing in detail exemplary embodiments with reference to the attached drawings in which:

FIG. 1A illustrates a digital driving technique performing a random scan for an organic light emitting display device, and FIG. 1B illustrates a digital driving technique performing a progressive scan for an organic light emitting display device;

FIG. 2 illustrates an embodiment of an organic light emitting display;

FIG. 3 illustrates a portion of a display panel in FIG. 2;

FIG. 4 illustrates an embodiment of a timing diagram for the panel in FIG. 3;

FIG. 5 illustrates another embodiment of a timing diagram for the panel;

FIG. 6 illustrates another example of a portion of a display panel in FIG. 2;

FIG. 7 illustrates an embodiment of a timing diagram for the panel in FIG. 6;

FIG. 8 illustrates operating switches based on the timing diagram; and

FIG. 9 illustrates an embodiment of a method for controlling an organic light emitting display device.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

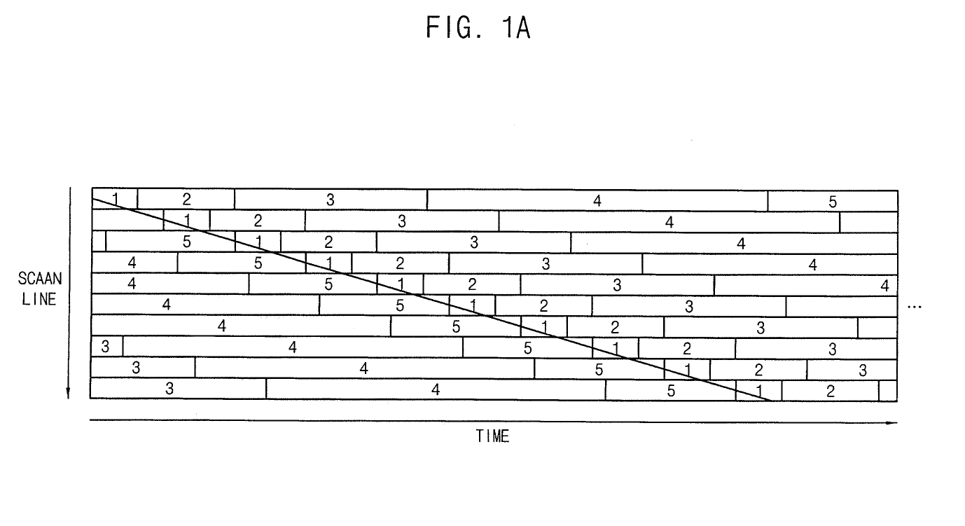

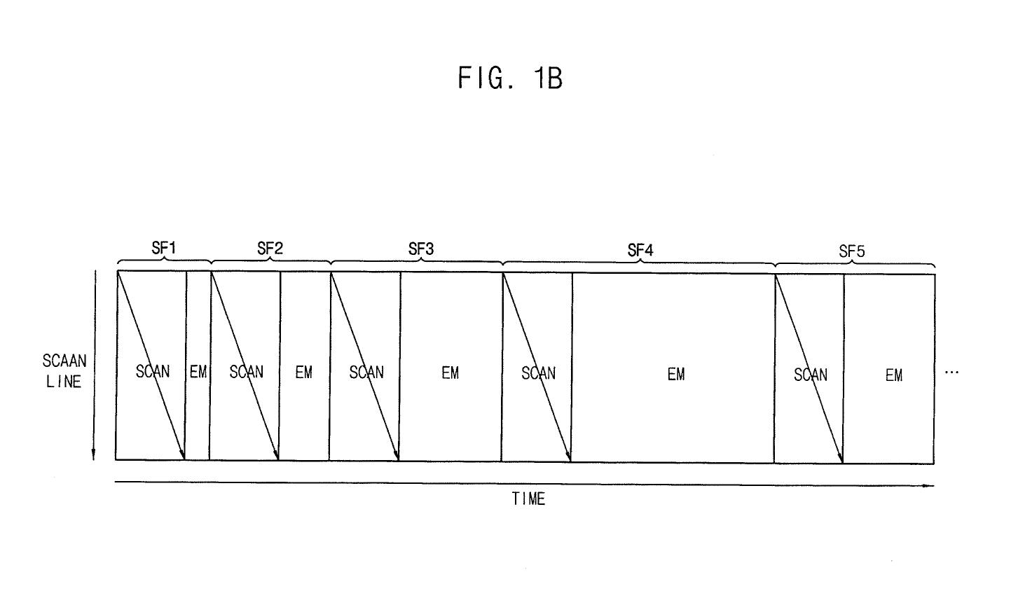

FIG. 1A illustrates a digital driving technique for performing a random scan for an organic light emitting display, and FIG. 1B illustrates a digital driving technique for performing a progressive scan for an organic light emitting display. Referring to FIGS. 1A and 1B, one frame is divided into a plurality of sub-frames. In FIGS. 1A and 1B, one frame is divided into first through fifth sub-frames SF1, SF2, SF3, SF4, and SF5, with the fifth sub-frame SF5 corresponding to a blank sub-frame. The number of sub-frames constituting one frame may be different in other embodiments, for example, determined according to required conditions or an intended application. In addition, the blank sub-frame SF5 may or may not be omitted in these other embodiments.

Each sub-frame SF1, SF2, SF3, SF4, and SF5 in one frame may have a scan time SCAN during which a scan signal is provided to pixels, an emission time EM during which the pixels emit light based on a data signal, and a reset time during which the pixels are reset (e.g., states of the pixels are changed from an emission state to a non-emission state). Except for the fifth sub-frame SF5 (e.g., the blank sub-frame), each emission time EM of the first through fourth sub-frames SF1, SF2, SF3, and SF4 differs by a factor of 2. That is, each emission time EM of the first through fourth sub-frames SF1, SF2, SF3, and SF4 is set differently. Thus, each emission time EM of the first through fourth sub-frames SF1, SF2, SF3, and SF4 corresponds to each bit of the data signal.

For example, as illustrated in FIGS. 1A and 1B, an emission time EM of the second sub-frame SF2 may be twice an emission time EM of the first sub-frame SF1. An emission time EM of the third sub-frame SF3 may be twice an emission time EM of the second sub-frame SF2. An emission time EM of the fourth sub-frame SF4 may be twice an emission time EM of the third sub-frame SF3. A sub-frame having the longest emission time EM (e.g., the fourth sub-frame SF4) corresponds to the most significant bit (MSB) of the data signal. A sub-frame having the shortest emission time EM (e.g., the first sub-frame SF1) corresponds to the least significant bit (LSB) of the data signal. As a result, a specific gray level is implemented based on a sum of the emission times EM of the first through fourth sub-frames SF1, SF2, SF3, and SF4.

As illustrated in FIG. 1A, the digital driving technique for performing a random scan randomly performs scan operations for all scan-lines for each sub-frame 1, 2, 3, 4, and 5. This is accomplished by shifting each sub-frame scan timing of the scan-lines by a specific time, and thus randomly (e.g., separately) performing emission operations for all scan-lines for each sub-frame 1, 2, 3, 4, and 5. The sub-frame emission order for all the scan-lines is fixed (e.g., in order of 1, 2, 3, 4, and 5).

As illustrated in FIG. 1B, the digital driving technique for performing the progressive scan sequentially performs scan operations for all scan-lines (indicated by arrows crossing SCAN to represent the sequential operations) during scan time SCAN for each sub-frame SF1, SF2, SF3, SF4, and SF5, and simultaneously performs emission operations for all scan-lines (indicated by no arrow crossing EM to represent simultaneous operations) during emission time EM for each sub-frame SF1, SF2, SF3, SF4, and SF5.

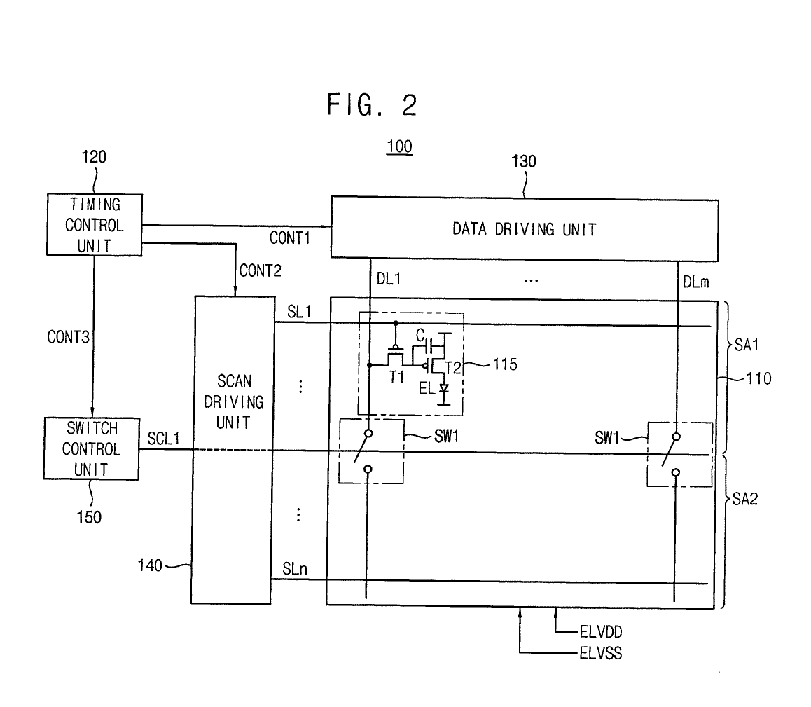

FIG. 2 illustrates an embodiment of an organic light emitting display 100 which includes a display panel 110, a timing control unit 120, a data driving unit 130, a scan driving unit 140, and a switch control unit 150. The organic light emitting display may further include a power supply unit.

The display device 110 includes a plurality of data lines DL1 through DLm each having a first switch SW1, a plurality of scan lines SL1 through SLn crossing the data lines DL1 through DLm, a first switch control line SCL1 arranged in parallel with the scan lines SL1 through SLn and connected to the first switch SW1, and a plurality of pixels 115. The pixels 115 are arranged in a matrix. In one embodiment, the number of the scan lines SL1 through SLn may be n (n is an integer greater than 0.), and the number of the data lines DL may be m (m is an integer greater than 0.). For example, the number of the pixels 115 may be n×m.

The pixel 115 may include a first transistor T1, a second transistor T2, and a storage capacitor C. The first transistor T1 includes a first electrode coupled to a data line DL1, a second electrode coupled to a gate electrode of the second transistor T2, and a gate electrode to receive a scan signal from a scan line SL1. The second transistor T2 includes a first electrode to receive a first power voltage ELVDD, a second electrode coupled to an organic light emitting diode EL, and a gate electrode to receive a data signal. The storage capacitor C is coupled between the gate electrode of the second transistor T2 and the first electrode of the second transistor T2. The data signal may be stored in the storage capacitor C when the scan signal is applied to the scan line SL1.

The first switch SW1 may include a MOS (Metal Oxide Semiconductor) transistor. The first switch control line SCL1 is connected to a gate electrode of the first switch SW1. The first switch SW1 be an NMOS (N-channel MOS) transistor or a PMOS (P-channel MOS) transistor. Each of the data lines DL1 through DLm may include the first switch SW1 at the same location. The switch control unit 150 is connected to the first switch control line SCL1 through an interface, which, for example, may be a port, a lead, or a signal line of a circuit or chip corresponding to the switch control unit 150.

A switching operation of the first switches SW1 may be simultaneously controlled by a switch control signal applied to the first switch control line SCL1. A first scan region SA1 of the display panel 110 and a second scan region SA2 of the display panel 110 may be divided by the first switch control line SCL1. The first scan region SA1, for example, may be closer to the data driving unit 130 than the first switch control line SCL1. Thus, the first scan region SA1 may include the scan lines located closer to the data driving unit 130 than the first switch control line SCL1. The second scan region SA2 may be farther from the data driving unit 130 than the first switch control line SCL1 in this embodiment. Thus, the second scan region SA2 may include the scan lines located farther from the data driving unit 130 than the first switch control line SCL1.

When the first switch SW1 is turned on, the data signal may be applied to a pixel in the second scan region SA2. On the other hand, when the first switch SW1 is turned off, the data signal may be not applied to the pixel in the second scan region SA2. However, theses are examples, and the number of switches in the data line and the number of switch control lines in the display panel 110 may be different in other embodiments. For example, each data line may include n (n is an integer greater than 1.) number of switches. The switches may be connected to n number of switch control lines, respectively. Thus, the display panel 110 including the plurality of scan lines SL1 through SLn may be divided to n+1 scan regions by n number of switch control lines. The switches may be switched depending on locations of a selected scan line to which the scan signal is applied among the scan lines SL1 through SLn.

The timing control unit 120 may generate first, second, and third control signals CONT1, CONT2 and CONT3 to respectively control the data driving unit 130, the scan driving unit 140, and the switch control unit 150. The timing control unit 120 may control the power supply unit. The second and third control signals CONT2 and CONT3, which are respectively applied to the scan driving unit 140 and the switch control unit 150, include scan line address information (e.g., location information) of the selected scan line when the display 100 is driven by the digital driving technique. The address information may have a predetermined number of the selected scan line or information of the scan region located the selected scan line.

The data driving unit 130 may apply a data signal to the pixels 115 via the data lines DL1 through DLm. Although it is illustrated in FIG. 2 that the display 100 includes one data driving unit 130, the display 100 may include two or more data driving units in other embodiments. In this case, one scan driving unit may be arranged in upper side from the display panel 110 to drive pixels in an upper region of the display panel 110, and another data driving unit may be arranged in a lower side of the display panel 110 to drive pixels in an lower region of the display panel 110.

The scan driver 140 may apply a scan signal to the pixels 115 via the scan lines SL1 through SLn. In one embodiment, when the organic light emitting display device 100 is driven by the digital driving technique (especially, in a random scan manner), the scan driving unit 140 may include a plurality of scan drive integrated circuits (e.g., scan ICs) respectively applying the scan signal to predetermined portions of the scan lines SL1 through SLn. The scan lines SL1 through SLn and/or the scan regions may have digital form address. The scan driving unit 140 may apply the scan signal to the selected scan line based on the second control signal CONT2 having the address information of the selected scan line. Thus, the scan signal may be randomly applied to the scan lines by the scan drive integrated circuits.

In one embodiment, the scan driving unit 140 may sequentially apply the scan signal to first to (n)th scan lines SL1 through SLn, when the organic light emitting display device 100 is driven by the digital driving technique for performing a progressive scan or an analog driving technique.

The switch control unit 150 may output a first switch control signal to the first switch control line SCL1 based on a location of the selected scan line to which the scan signal is applied among the scan lines SL1 through SLn. The switch control unit 150 may output the first switch control signal to the first switch control line SCL1 in response to the third control signal CONT3. The first switch control signal may have a turn-on voltage turning on the first switch SW1 and a turn-off voltage turning off the first switch SW2. The first switch SW1 may be turned on when the turn-on voltage of the first switch control signal is applied from the first switch control line SCL1 to the first switch SW1, and may be turned off when the turn-off voltage of the first switch control signal is applied from the first switch control line SCL1 to the first switch SW1.

If the first switch SW1 includes a PMOS transistor, a low level voltage of the first switch control signal may be referred to as the turn-on voltage, and a high level voltage, higher than the low level voltage, of the first switch control signal may be referred to as the turn-off voltage. If the first switch SW1 includes an NMOS transistor, a high level voltage of the first switch control signal may be referred to as the turn-on voltage, and a low level voltage, lower than the high level, of the first switch control signal may be referred to as the turn-off voltage.

The switch control unit 150 may output the turn-off voltage of the first switch control signal to the first switch control line SCL1, when the selected scan line (e.g., a first scan line SL1 to which the scan signal is applied) is located in the first scan region SA1 of the display panel 110. Thus, the first switch SW1 may be turned off so that a pixel in the second region SA2 may be disconnected to the data driving unit 130, and the data signal may not be applied to the pixel in the second scan region SA2.

The switch control unit 150 may output the turn-on voltage of the first switch control signal to the first switch control line SCL1, when the selected scan line (e.g., an (n)th scan line SLn to which the scan signal is applied) is located in the second scan region SA2 of the display panel 110. Thus, the first switch SW1 may be turned on so that the data signal may be applied to the second scan region SA2.

The second and third control signals CONT2 and CONT3, which are respectively applied to the scan driving unit 140 and the switch control unit 150, may include the address information (e.g., location information) of the selected scan line when the display 100 is driven by the digital driving technique. Thus, the switch control unit 150 may receive the address information, and may output the turn-on voltage or the turn-off voltage of the first switch control signal to the first switch control line SCL1 based on the address information.

In an example embodiment, the switch control unit 150 may be physically included in the scan driving unit 140. For example, a plurality of switch control units 150 may be included in the scan ICs, respectively.

The power supply unit may generate the first power voltage ELVDD and a second power voltage ELVSS. The power supply unit may supply the first and second power voltages ELVDD and ELVSS to the pixels 115 through a plurality of power lines.

As described above, each of the data lines DL1 through DLm in display 100 may have the first switch SW1. When the data signal is applied to the pixel in the first scan region SA1, the first switch SCL1 may be turned off. Thus, when the first switch SCL1 is turned off, the actual length of the data lines DL1 through DLm transmitting the data signal may be shortened and resistance (or impedance) and parasitic capacitance of the data lines may be decreased, so that a drive current for driving the display panel 110 may decrease. The current applied to the display panel 110 decreases to allow for a decrease in power consumption of the data driving unit 130. As a result, heating and a burn-in problem of the display panel 110 may be improved. Further, reliability of large size organic light emitting displays may be improved.

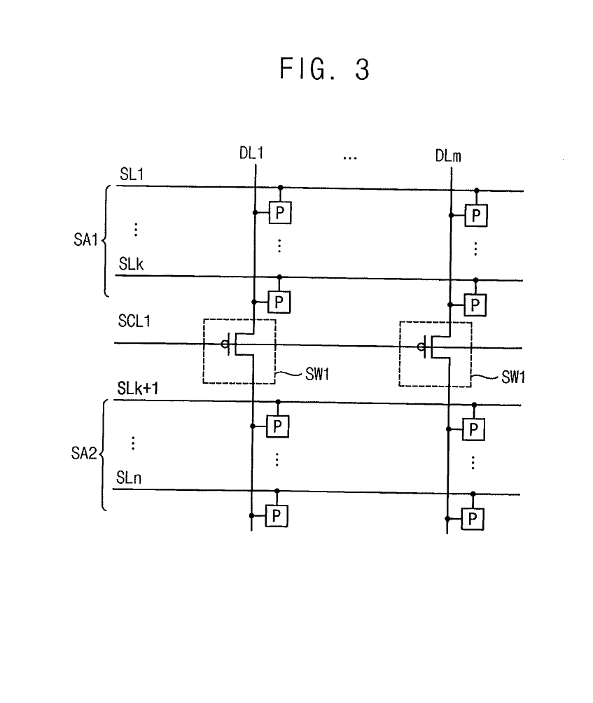

FIG. 3 illustrates an example of a portion of the display panel 110 of the display in FIG. 2. Referring to FIG. 3, data lines DL1 through DLm may include first switches SW1. The first switches SW1 are connected to a first switch control line SCL1 to allow the first switches SW1 to be simultaneously switched.

A first scan region SA1 may be closer to the data driving unit 130 than the first switch control line SCL1, and first through (k)th (k is an integer smaller than n and greater than 1) scan lines SL1 through SLk are located (or, included) in the first scan region SA1. A second scan region SA2 may be farther from the data driving unit 130 than the first switch control line SCL1, and (k+1)th through (n)th scan lines SLk+1 through SLn are located in the second scan region SA2. The number of scan lines in the first scan region SA1 may be the same as the number of the scan lines in the second scan region SA2. For example, when the display 100 has 1080 scan lines, first through 540th scan lines may be in the first scan region SA1, and 541th through 1080th scan lines may be in the second scan region SA2. In another embodiment, the number of scan lines in the first scan region SA1 may be different from the number of scan lines in the second scan region SA2.

The first switch SW1 may be turned on when a turn-on voltage of a first switch control signal is applied from the first switch control line SCL1 to the first switch SW1. The first switch SW1 may include, for example, a MOS transistor, and the first switch control line SCL1 may be connected to a gate electrode of the first switch SW1.

When a scan signal is applied among the first through (k)th scan lines, the switch control unit 150 may output the turn-off voltage of the switch control signal to the first switch control line SCL1. Thus, the first switch SW1 may be turned off so that a data signal is not applied to the second scan region SA2. Portions of the data lines DL1 through DLm corresponding to the second scan region SA2 may be disconnected to the data driving unit 130, so that resistance (or impedance) and parasitic capacitances of the data lines DL1 through DLm may decrease. Thus, current for driving the display panel 110 may decrease.

When a scan signal is applied among the (k+1)th through (n)th scan lines, the switch control unit 150 may output the turn-on voltage of the switch control signal to the first switch control line SCL1. Thus, the first switch SW1 may be turned on so that a data signal may be applied to the second scan region SA2. In another embodiment, each data line may include a different number of switches and/or a different number of switch control lines. For example, each data line may include j (j is an integer greater than 1) number of switches. The switches may be connected to j number of switch control lines, respectively. Thus, the display panel 110 including the plurality of scan lines SL1 through SLn may be divided to j+1 scan regions by j number of switch control lines.

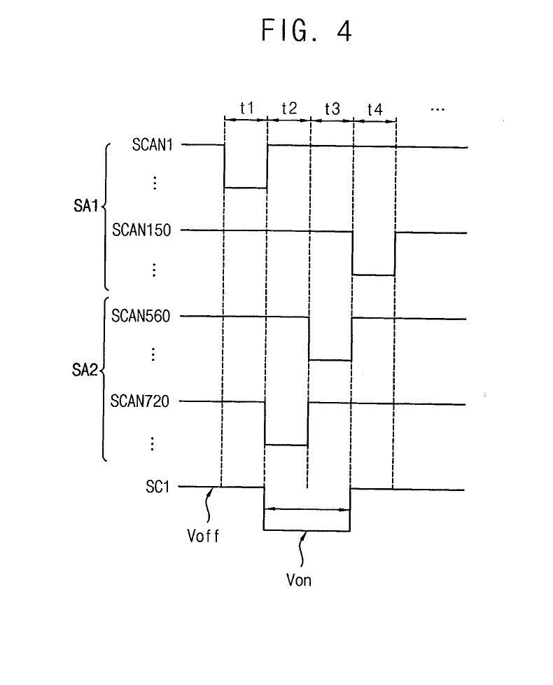

FIG. 4 illustrates an embodiment of a timing diagram including signals applied to the display panel of FIG. 3. The signals include scan signals and a switch control signal to be applied in a digital driving technique for performing a random scan.

Referring to FIG. 4, the scan driving unit 140 may output a scan signal among a plurality of scan lines for each sub-frame. The switch control unit 150 may output a first switch control signal SC1 to a switch control line in response to the scan signal. The scan driving unit 140 and the switch control unit 150 may be as described with reference to FIG. 2.

Hereinafter, operation of the organic light emitting display 100 will be explained for the illustrative case where the display 100 includes 1080 scan lines. A first scan line may be the closest to the data driving unit 130 among the scan lines and a 1080th scan line may be the farthest scan line from the data driving unit 130 among the scan lines.

The number of scan lines in the first scan region SA1 may be the same as the number of scan lines in a second scan region SA2. For example, first through 540th scan lines may be in the first scan region SA1, and 541th through 1080th scan lines may be in the second scan region SA2. In this case, the first scan control line may be located between the 540th scan line and the 541th scan line.

As illustrated in FIG. 4, the scan signal may be applied to the first scan line SCAN1 in a first time period t1 (e.g., the first scan line is a selected scan line in the first time period t1), the scan signal may applied to a 720th scan line SCAN720 in a second time period t2, the scan signal may be applied to a 560th scan line SCAN560 in a third time period t3, and the scan signal may be applied to a 150th scan line SCAN150 in a fourth time period t4. Accordingly, in this embodiment, the first scan line SCAN1 is the selected scan line in the first time period t1, the 720th scan line SCAN720 is the selected scan line in the second time period t2, 560th scan line SCAN560 is the selected scan line in the third time period t3, and the 150th scan line SCAN150 is the selected scan line in the fourth time period t4. The first and 150th scan lines SCAN1 and SCAN150 may be in the first scan region SA1, and the 560th and 720th scan lines SCAN560 and SCAN720 may be in the second scan region SA2.

A turn-off voltage Voff of the first switch control signal SC1 may be applied to the first switch control line when the selected scan line is in the first scan region SA1 of the display panel 110. A turn-on voltage Von of the first switch control signal SC1 may be applied to the first switch control line when the selected scan line is in the second scan region SA2 of the display panel 110. A first switch may be turned off when the turn-off voltage Voff of the first switch control signal SC1 is applied to the first switch. The first switch may be turned on when the turn-off voltage Von of the first switch control signal SC1 is applied to the first switch.

Thus, the first switch control signal SC1 may have the turn-off voltage Voff in the first time period t1 and fourth time period t4, and may have the turn-on voltage Von in the second time period t2 and third time period t3. The switch control unit 150 may output the turn-on voltage Von or the turn-off voltage Voff of the first switch control signal SC1 based on address information of the selected scan line. For example, if the address information corresponds to a scan line in the first scan region SA1, the switch control unit 150 may output the turn-off voltage Voff. If the address information corresponds to a scan line in the second scan region SA2, the switch control unit 150 may output the turn-off voltage Von. The address information may be generated in the timing control unit 120 and applied to the scan driving unit 140 and the switch control unit 150. The number of scan lines in the first scan region SA1 may be the same or different from the number of scan lines in the second scan region SA2.

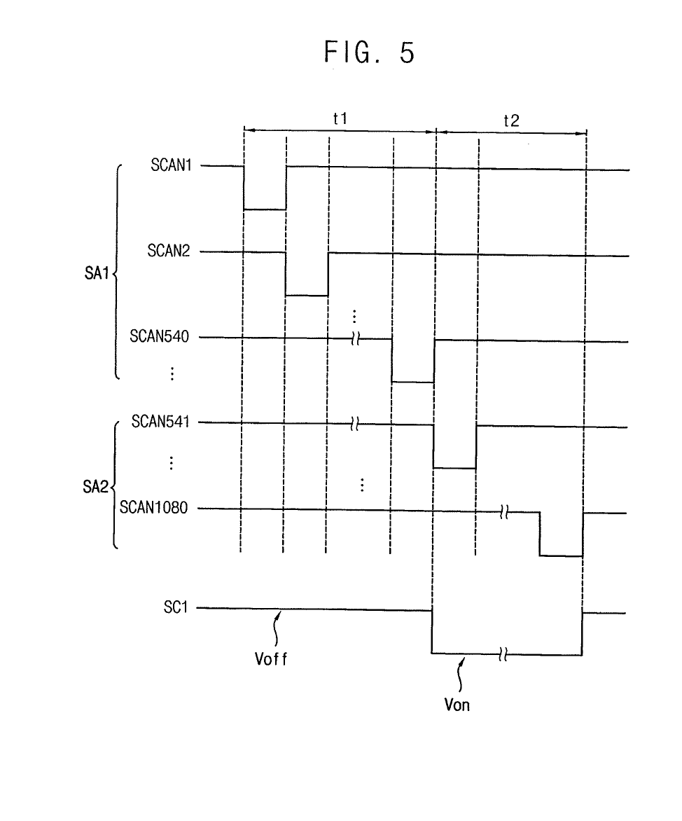

FIG. 5 illustrates another embodiment of a timing diagram including signals to be applied to the display panel of FIG. 3. These signals include scan signals and a switch control signal to be applied in a digital driving technique for performing a progressive scan.

Referring to FIG. 5, the scan driving unit 140 may sequentially output a scan signal among a plurality of scan lines for each sub-frame. The switch control unit 150 may output a first switch control signal SC1 to a switch control line in response to the scan signal. The first through 540th scan lines may be in a first scan region SA1 and 541th through 1080th scan lines may be in a second scan region SA2. In this case, the first scan control line may be between the 540th scan line and the 541th scan line.

In operation, a scan signal may be sequentially applied to first through 540th scan lines SCAN1, SCAN2, . . . SCAN540 during a first time period t1. The scan signal may be sequentially applied to 541th through 1080th scan lines SCAN541 through SCAN1080 during a second time period t2. Thus, the switch control signal SC1 may have a turn-off voltage Von in the first time period t1, and may have the turn-on voltage Von in the second time period t2. In one embodiment, the switch control unit 150 may output the turn-on voltage or the turn-off voltage of the first switch control signal SC1 based on address information of the selected scan line. The first switch may be turned off in the first time period t1 and turned on in the second time period t2.

When the organic light emitting display device operates based on an analog driving technique, forms of the scan signal and the first switch control signal may be similar to (or, substantially the same as) the timing diagram of FIG. 5.

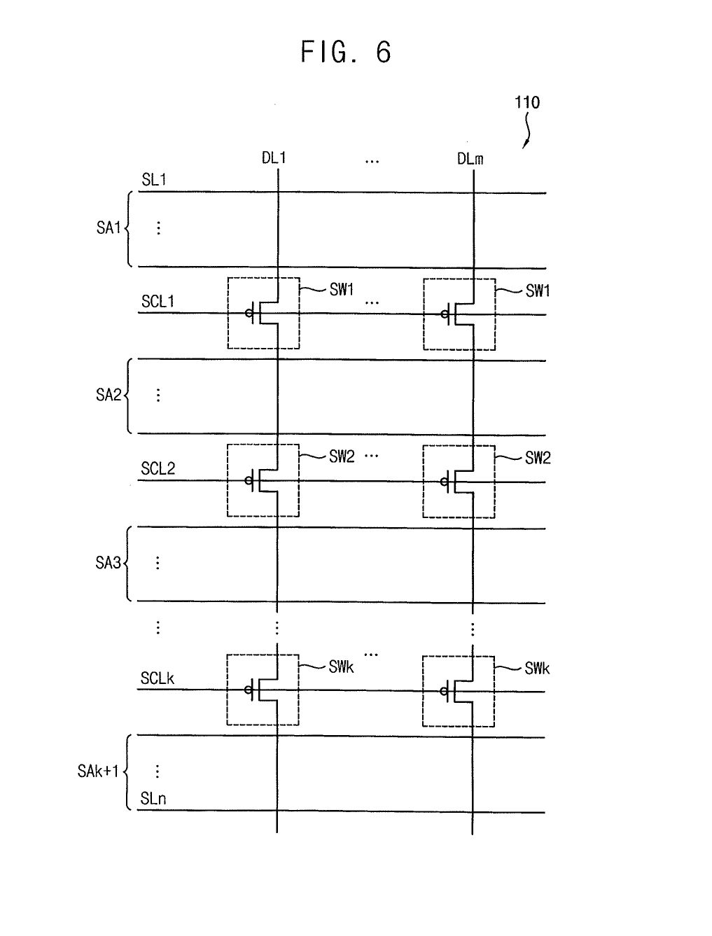

FIG. 6 illustrates another example of a portion of a display panel of the organic light emitting display in FIG. 2. Referring to FIG. 6, the display panel 110 includes a plurality of data lines DL1 through DLm each having first through (k)th (k is an integer greater than 3) switches SW1, SW2, . . . SWk, a plurality of scan lines SL1 through SLn crossing the data lines DL1 through DLm, a plurality of switch control lines SCL1, SCL2, . . . SCLk arranged in parallel with the scan lines SL1 through SLn. Each of the first through (k)th switches may include, for example, a MOS transistor.

A second switch SW2 may be located farther from the data driving unit 130 than first switch SW1. A second switch control line SCL2 may be arranged in parallel with the scan lines SL1 through SLn, and may be connected to a gate electrode the second switch SW2. First switches SW1 are connected to the first switch control line SCL1 to allow the first switches SW1 to be simultaneously switched. Second switches SW2 are connected to the second switch control line SCL2 to allow the second switches SW2 to be simultaneously switched.

The switch control unit 150 may output a first switch control signal to the first switch control line SCL1 and a second switch control signal to the second switch control line SCL2 based on a location of the selected scan line to which the scan signal is applied, among the scan lines SL1 through SLn. The first switch SW1 may be turned on by receiving a turn-on voltage of the first switch control signal from the first switch control line SCL1, and may be turned off by receiving a turn-off voltage of the first switch control signal from the first switch control line SCL1. The second switch SW2 may be turned on by receiving a turn-on voltage of the second switch control signal from the second switch control line SCL2, and may be turned off by receiving a turn-off voltage of the second switch control signal from the second switch control line SCL2.

A first scan region SA1 may be closer to the data driving unit 130 than the first switch control line SCL1. A second scan region SA2 may be between the first switch control line SCL1 and the second switch control line SCL2. A third scan region SA3 may be farther from the data driving unit than the second switch control line SCL3. The (k)th switch may be included, for example, in each data line. Then, a (k+1)th scan region SAk+1 may be farther from the data driving unit than the (k)th switch control line SCLk.

The number of scan lines in each scan region may be the same. For example, the when the display includes 1080 scan lines and 3 switch control lines, a first through fourth scan regions may include 270 scan lines, respectively. In another embodiment, the number of scan lines in each scan region may be different.

The first through (k)th switches SW1, SW2, . . . , SWk may be turned off when the selected scan line is in the first scan region SA1. In this case, the switch control unit 150 may output a turn-off voltage of the first through (k)th switch control signals to the first through (k)th switch control lines SCL1, SCL2, . . . , SCLk, respectively. Thus, the first switch SW1 may be turned off so that a data signal may be applied to the first scan region SA1.

The first switch SW1 may be turned on and the second through (k)th switches SW2 through SWk may be turned off when the selected scan line is in the second scan region SA2. In this case, the switch control unit 150 may output a turn-on voltage of the first switch control signal to the first switch control line SCL1. Thus, the data signal may be applied to the second scan region SA2.

The first switch SW1 and the second switch SW2 may be turned on when the selected scan line is in the third scan region SA3. In this case, the switch control unit 150 may output the turn-on voltage of the first switch control signal to the first switch control line SCL1 and the turn-on voltage of the second switch control signal to the second switch control line SCL2.

Similarly, the first through (k)th switches SW1, SW2, . . . SWk may be turned on when the selected scan line is in the (k+1)th scan region SAk+1. In this case, the switch control unit 150 may output the turn-on voltage of the first through (k)th switch control signals to the first through (k)th switch control lines SCL1, SCL2, . . . SCLk, respectively. Thus, the data signal may be applied to the (k+1)th scan region SAk+1.

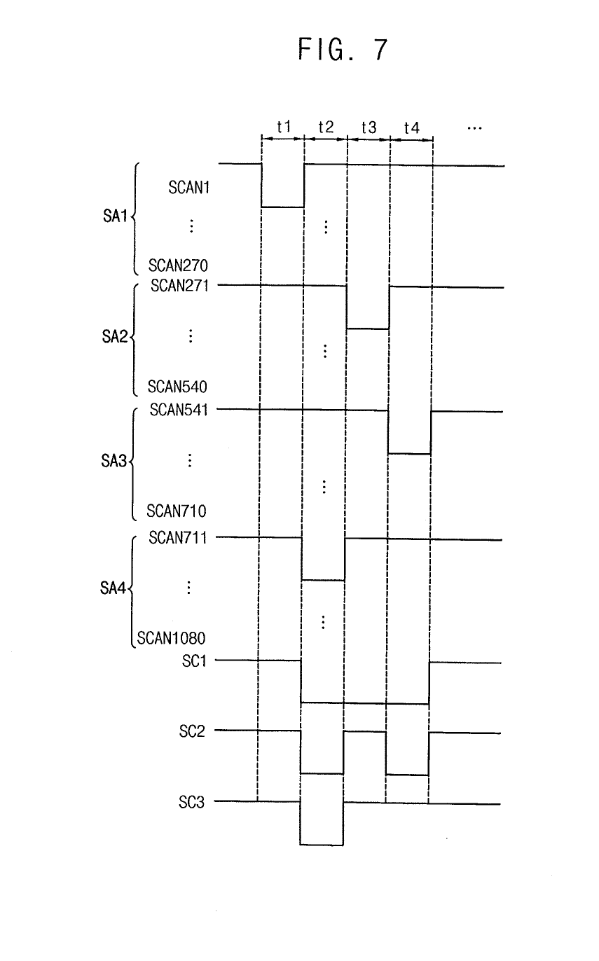

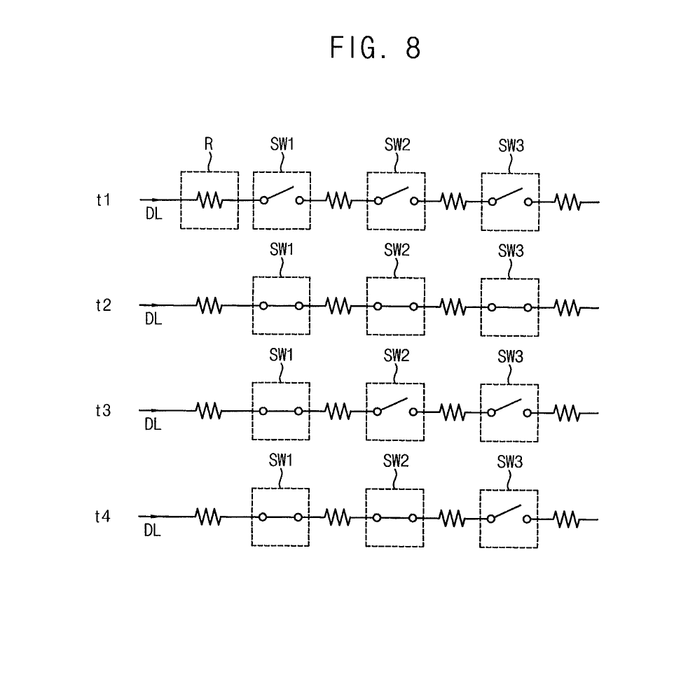

FIG. 7 illustrates an embodiment of a timing diagram including signals to be applied to the display panel in FIG. 6, and FIG. 8 illustrates an example of operating switches based on the signals of FIG. 7.

Referring to FIGS. 7 and 8, the display panel includes 1080 scan lines, first, second and third switch control lines, and first, second and third switches SW1, SW2 and SW3. The display 100 may be operated by a digital driving technique for performing a random scan.

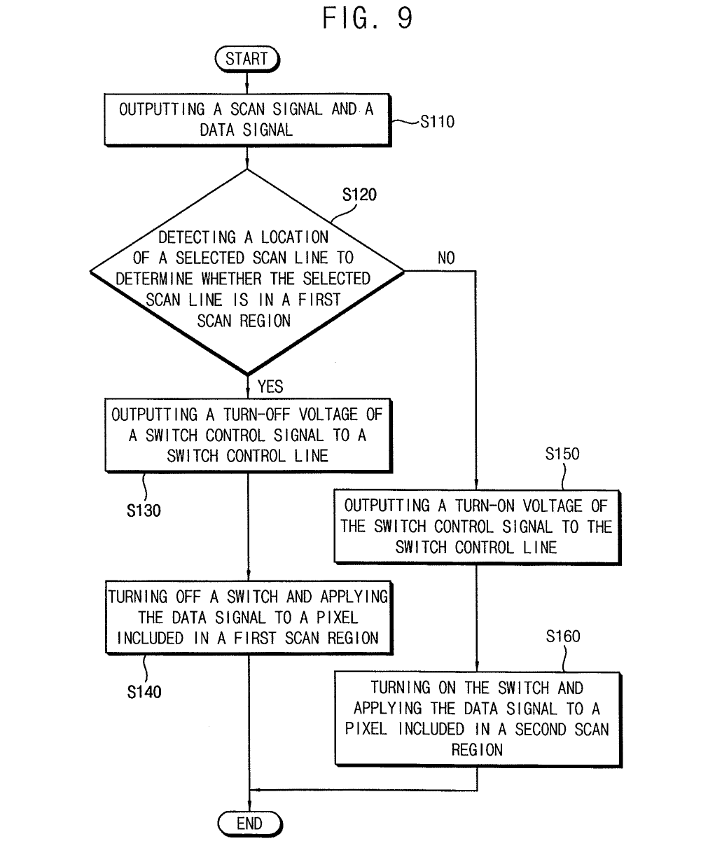

The first, second and third switches SW1, SW2, and SW3 may be in each data line DL. The display panel may be divided to first, second, third and fourth scan regions SA1, SA2, SA3 and SA4 by the first, second and third switch control lines. The first, second, and third switches SW1, SW2, and SW3 may be switched by receiving first, second, and third switch control signals SC1, SC2 and SC3, respectively. A data signal (e.g., a data voltage) may be dropped (e.g., IR drop) by resistance (or impedance) of the data line DL and/or parasitic capacitance with other lines (e.g., indicated by R in FIG. 9).

The first, second, third and fourth scan regions SA1, SA2, SA3, and SA4 may include the same number of scan lines. For example, the first, second, third and fourth scan regions SA1, SA2, SA3, and SA4 may respectively include 270 scan lines. The first switch control line may be located between a 270th scan line and a 271th scan line, the second switch control line may be located between a 540th scan line and a 541th scan line, and the second switch control line may be located between a 710th scan line and a 711th scan line. In another embodiment, two or more of the first, second, third and fourth scan regions SA1, SA2, SA3 and SA4 may have different numbers of scan lines.

As illustrated in FIGS. 7 and 8, the scan signal may be applied to the first scan line SCAN1 in a first time period t1 (e.g., the first scan line is a selected scan line in the first time period 11). The first scan line SCAN1 may be in the first scan region SA1. The switch control unit may output the first, second, and third switch control signals SC1, SC2, and SC3, each having a turn-off voltage, to the first, second, and third switch control lines, respectively. The first, second and third switches SW1, SW2, and SW3 may be turned off by respectively receiving the first, second, and third switch control signals SC1, SC2, and SC3, each having the turn-off voltage. Thus, the resistance (or impedance) and the parasitic capacitance of the data line DL may decrease so that power consumption may decrease.

The scan signal may be applied to a 711th scan line SCAN711 in a second time period t2 (e.g., the 711th scan line is a selected scan line in the second time period t2). The 711th scan line SCAN711 may be in the fourth scan region SA4. The switch control unit may output the first, second and third switch control signals SC1, SC2, and SC3, each of which has a turn-on voltage to a respective one of the first, second, and third switch control lines. The first, second, and third switches SW1, SW2, and SW3 may be turned on by receiving respective ones of the first, second, and third switch control signals SC1, SC2, and SC3, each of which has the turn-on voltage. Thus, the data signal may be applied a pixel connected to the 711th scan line SCAN711.

The scan signal may be applied to a 271th scan line SCAN271 in a third time period t3 (e.g., the 271th scan line is a selected scan line in the third time period t3). The 271th scan line SCAN271 may be in the second scan region SA2. The switch control unit may output the first switch control signal SC1 having the turn-on voltage to the first switch control line. The switch control unit may output the second and third switch control signals SC2 and SC3, each of which has the turn-off voltage to a respective one of the second and third switch control lines. The first switch SW1 may be turned on by receiving the first switch control signal SC1 having the turn-on voltage. The second and third switches SW2 and SW3 may be turned off by receiving respective ones of the second and third control signals, each having the turn-off voltage. Thus, the resistance (or impedance) and the parasitic capacitance of the data line DL may decrease so that power consumption may decrease.

The scan signal may be applied to a 541th scan line SCAN541 in a fourth time period t4 (e.g., the 541th scan line is a selected scan line in the fourth time period t4). The 541th scan line SCAN541 may be in the third scan region SA3. The switch control unit may output the first and second switch control signals SC1 and SC2, each having the turn-on voltage, to the first and second switch control lines, respectively. The switch control unit may output the third switch control signal SC3 having the turn-off voltage to the third switch control line. The first and second switches SW1 and SW2 may be turned on by receiving respective ones of the first and second switch control signals SC1, each having the turn-on voltage. The third switch SW3 may be turned off by receiving the third control signal having the turn-off voltage.

The switch driving unit 150 receives the address information, and outputs the first, second, and third switch control signals SC1, SC2, and SC3 to the first, second, and third switch control lines based on the address information. The address information may include information of a predetermined number of the selected scan line or information of the scan region of the selected scan line. For example, when the switch control unit 150 receives address information of the selected scan line in the second scan region SA2, the switch control unit 150 outputs the first switch control signal SC1 having the turn-on voltage to the first switch control line and outputs the second and third control signals SC2 and SC3, each having the turn-off voltage, to the second and third switch control lines, respectively.

Thus, an organic light emitting display may include a data line having at least one switch which is turned on depending on the location of the selected scan line, so that current for driving the display panel may decrease. The reduced current applied to the display panel allows for a reduction in power consumption of the data driving unit. As a result, heating and burn-in problem of the display panel may be improved. Further, the reliability of large size organic light emitting display may be improved.

FIG. 9 illustrates an embodiment of a method for controlling an organic light emitting display based on a digital driving technique. Referring to FIG. 9, the method includes outputting a scan signal and a data signal S110, and detecting the location of a selected scan line to which the scan signal is applied among a plurality of scan lines S120.

When the location of the selected scan line is detected in a first scan region that is closer to a data driving unit than the switch control line, a turn-off voltage of a switch control signal is output to a switch control line S130, and a switch connected with the switch control line is turned off S140. Then, the data signal may be applied to a pixel in the first scan region.

When the location of the selected scan line is in a second scan region that is farther from the data driving unit than the switch control line, a turn-on voltage of the switch control signal is output to the switch control line S150, and the switch is turned on S160. Then, the data signal may be applied to a pixel in the second scan region.

A scan driving unit may output the scan signal to the selected scan line and a data driving unit may output the data signal to the data line S110. The data line may include at least one switch.

A switch control unit may output the switch control signal to the switch control line based on the location of the selected scan line. The switch control line may be parallel with the scan lines. In one embodiment, the switch control unit may detect the location of the selected scan line S120. For example, control signals applied to the scan driving unit and the switch control unit may include scan line address information of the selected scan line. The scan line address information may be a digital signal. The scan line address information may have a predetermined number of the selected scan line or the scan region located the selected scan line. Thus, the switch control unit may detect whether the selected scan line is in the first scan region S120, e.g., whether the selected scan line is closer to the data driving unit than the switch control line.

The switch control unit may output the turn-off voltage of the switch control signal to the switch control line S130, when the location of the selected scan line is in the first scan region. The first scan region may be closer to a data driving unit than the switch control line.

The switch may be turned off by the turn-off voltage of the switch control signal S140, so that the data signal may be applied to the pixel in the first scan region. The switch may be connected to the switch control signal. The pixel in the second region may be disconnected to the data driving unit, so that the data signal may not be applied to the pixel in the second region. Thus, actual length of the data line transmitting the data signal may be shortened and resistance (or impedance) and parasitic capacitance of the data lines may be decreased.

The switch control unit may output the turn-on voltage of the switch control signal to the switch control line S150, when the location of the selected scan line is detected in the second scan region. The second scan region may be farther from the data driving unit than the switch control line. The switch may be turned on by the turn-on voltage of the switch control signal S160, so that the data signal may be applied to the pixel in the second scan region. The number of scan lines in the first scan region may be the same as or different from the number of scan lines in the second scan region.

In one embodiment, the organic light emitting display may include at least one switch control line, and each data line may include at least one switch corresponding to respective switch control lines. Operations of each switch by a corresponding switch control signal may be as described above with reference to FIGS. 2 through 8.

By way of summation and review, in large size and high-resolution organic light emitting display devices, the number of pixels receiving data signals increase. Also, the display panel load (caused by increasing resistance (or impedance) of panel lines and parasitic capacitance) increases. Thus, a pixel driving voltage and a current applied from a data driving unit to a display panel must increase to maintain a display quality. However, as the drive current increases, power consumption of the data driving unit increases and a heating problem of the display panel and drive integrated circuits occurs.

In accordance with one or more embodiments, a method for controlling an organic light emitting display employing a digital driving technique turns on or off a switch in a data line based on the location of the selected scan line. When the switch is turned off, resistance (or impedance) and parasitic capacitance of the data lines may decrease, so that a voltage drop (e.g., IR-drop) of the data signal decreases. Further, a drive current for driving the display panel may decrease, so that power consumption of the data driving unit may be decreased. As a result, heating and/or burn-in problem of the display panel may be improved.

The present embodiments may be applied to any display device and any system including the display device. For example, the present embodiments may be applied to a television, a computer monitor, a laptop, a digital camera, a cellular phone, a smart phone, a smart pad, a personal digital assistant (PDA), a portable multimedia player (PMP), a MP3 player, a navigation system, a game console, a video phone, etc.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. An organic light emitting display device, comprising:
a display panel including a plurality of data lines, a plurality of scan lines, a first switch control line, and a plurality of pixels, the data lines including first switches connected to the first switch control line,
a data driver to output a data signal to the data lines;
a scan driver to output a scan signal to the scan lines;
a switch controller to output a first switch control signal to the first switch control line based on a location of a selected scan line to which the scan signal is applied; and
a timing controller to control the data driver, the scan driver, and the switch controller.

2. The device as claimed in claim 1, wherein the first switch is turned on when a turn-on voltage of the first switch control signal is applied from the first switch control line to the first switch, and is turned off when a turn-off voltage of the first switch control signal is applied from the first switch control line to the first switch.

3. The device as claimed in claim 2, wherein the first switch control line is connected to a gate electrode of the first switch.

4. The device as claimed in claim 2, wherein the first switch is turned off when the selected scan line is in a first scan region of the display panel.

5. The device as claimed in claim 4, wherein the first scan region is closer to the data driver than the first switch control line.

6. The device as claimed in claim 4, wherein the first switch is turned on when the selected scan line is located in a second scan region of the display panel.

7. The device as claimed in claim 6, wherein the second scan region is farther from the data driver than the first switch control line.

8. The device as claimed in claim 7, wherein a number of the scan lines in the first scan region is equal to a number of the scan lines in the second scan region.

9. The device as claimed in claim 7, wherein a number of the scan lines in the first scan region is different from a number of the scan lines in the second scan region.

10. The device as claimed in claim 2, wherein each of the data lines includes a second switch located farther from the data driver than the first switch.

11. The device as claimed in claim 10, wherein the display panel includes a second switch control line farther from the data driver than the first switch control line, the second switch control line connected to a gate electrode of the second switch.

12. The device as claimed in claim 11, wherein:
the switch controller outputs a second switch control signal to the second switch control line based on the location of the selected scan line, and
the second switch is turned on when a turn-on voltage of the second switch control signal is applied from the second switch control line to the second switch, and is turned off when a turn-off voltage of the second switch control signal is applied from the second switch control line to the second switch.

13. The device as claimed in claim 12, wherein the first switch and the second switch are turned off when the selected scan line is in a first scan region of the display panel.

14. The device as claimed in claim 13, wherein the first switch is turned on and the second switch is turned off when the selected scan line is in a second scan region of the display panel.

15. The device as claimed in claim 14, wherein the first switch and the second switch are turned on when the selected scan line is in a third scan region of the display panel.

16. The device as claimed in claim 15, wherein:
the first scan region is closer to the data driver than the first switch control line,
the second scan region is between the first switch control line and the second switch control line, and
the third scan region is farther from the data driver than the second switch control line.

17. A method of driving an organic light emitting display device performing a digital driving technique, the method comprising:
outputting a scan signal and a data signal;
detecting a location of a selected scan line to which the scan signal is applied;
outputting a turn-off voltage of a switch control signal to a switch control line when the location of the selected scan line is in a first scan region closer to a data driver than the switch control line;
turning off a switch connected with the switch control line by the turn-off voltage of the switch control signal to apply the data signal to a pixel in the first scan region, the switch included in a data line;
outputting a turn-on voltage of the switch control signal to the switch control line when the location of the selected scan line is in a second scan region farther from the data driver than the switch control line; and
turning on the switch by the turn-on voltage of the switch control signal to apply the data signal to a pixel in a second scan region.

18. The method as claimed in claim 17, wherein a number of the scan lines in the first scan region is equal to a number of the scan lines in the second scan region.

19. The method as claimed in claim 17, wherein a number of the scan lines in the first scan region is different from a number of the scan lines in the second scan region.

20. An apparatus, comprising:
an interface; and
a controller to output a first switch control signal to a first switch control line through the interface, wherein the first control line is connected to first switches in a respective number of data lines in a display panel, and wherein the controller is to output the first switch control signal based on a location of a selected scan line to which a scan signal is applied in the display panel.
